(19) United States
(12) Patent Application Publication
(10) Pub. No.: US 2010/0010884 A1
(43) Pub. Date: Jan. 14, 2010

(54) Method And System For Customizable Video Advertising

(75) Inventors: Brian Cohee, Shoreline, WA (US); David Meeuwis, Victoria (CA); Brian Oraas, Victoria (CA); Anupam Gupta, Redmond, WA (US); Matthew Bartholomew, Everett, WA (US)

Correspondence Address: Soquel Group, LLC, P.O. Box 691, Soquel, CA, 95073, US

(73) Assignee: MIXPO PORTFOLIO BROADCASTING, INC., Seattle, WA (US)

(21) Appl. No.: 12/173,010

(22) Filed: Jul. 14, 2008

(51) Int. Cl. G06Q 30/00; G06Q 10/00

(52) U.S. Cl. 705/14.12; 705/7

(57) ABSTRACT

A method and system for publishing video ads on Web pages, comprising providing a publisher interface for interactively specifying a video ad by a publisher wherein a video ad comprises one or more media clips and, optionally, one or more interactive controls, generating by the publisher interface a playlist that specifies the video ad wherein said playlist includes references to said one or more media clips and said optional interactive controls, storing by the publisher interface the playlist in a storage system, downloading the playlist from the storage system to a smart media player capable of processing said playlist, in response to a user request, and playing the video ad by the smart media player.

### FIELD OF THE INVENTION

The subject invention relates to multimedia broadcasting and advertising over the Internet.

### BACKGROUND OF THE INVENTION

Increasingly, companies are turning to online video to advertise their products and services. For example, companies frequently describe aspects of their businesses by publishing video advertisements on their websites. Further, it is common on commercial websites to show a short video advertisement or “video ad” prior to the video clip that an individual has requested. Short video ads shown prior to the content requested by viewers are referred to as “pre-rolls.” In some cases, a website that shows video advertisements has some information about the viewer requesting the video clip that may be used to provide targeted or customized advertising specific to the viewer. For example, if the viewer has signed on to the website and the website has previously collected personal information from the user then the website can in turn provide to the advertiser information such as the user's age, gender, or geographic location. In addition, it is possible to obtain geographic coordinates for the IP (internet protocol) address of the viewer. An advertiser could then use such information about the viewer to customize an ad, taking into account geographic or other information.

Video advertisements, infomercials, and business-related videos are typically created on a client computer, uploaded to an online video advertising system on a central server, and then distributed upon request by a viewer from the central server to the viewer's Web browser. Other client computers typically display the video clip using a media player that operates as a plug-in or otherwise in conjunction with a Web browser. Popular media players include Apple® Quicktime®, Microsoft® Media Player, Adobe® Flash®, and RealPlayer by RealNetworks. Popular Web browsers include Microsoft Internet Explorer® and Mozilla Firefox. A client computer may also be a mobile device such as a RIM® Blackberry® that runs a mobile Web browser.

Typically, if a change or update needs to be made to the video file (for example, customizing an address based on geographic information about the viewer), the file must be edited on a client computer using video editing software such as Microsoft Windows® Movie Maker, or Apple's iMovie® and resubmitted to the hosting server with a different name. The reason for this time consuming process is that prior art video publishing and video advertising systems require that a video be submitted as a single video file in a standard format. Thus, prior to submitting a video the video editing software must merge or flatten all of the individual media elements (digital video, sound or music, and text files) of which a video is composed to create a video output file capable of being uploaded to an online advertising system.

Therefore, to facilitate the creation of customized Internet video ads it is advantageous to store on the server a representation of an advertisement in which the media elements have not been merged. In such a system it is possible to customize an advertisement on the server simply by changing the elements that are to be customized. For example, a text overlay that provides the address of the nearest automobile dealership can be readily modified.

However, due to the large number of possible combinations involved in customized advertising it is computationally prohibitive to have server computers generate new video clips in real-time in response to viewer requests. Moreover, such a server-based approach might result in delays while the server is generating the new video clip that might be undesirable to the viewer. Therefore, it is advantageous to have a client-based approach that enables creation of a customized video ad at the time a viewer requests playback of a video ad. Further, it is advantageous if the client can render the customized ad in real-time thus avoiding network transmission delays or server-based processing delays.

Media players are becoming increasingly programmable, thus enabling the creation of video ads on-the-fly. SMIL (Synchronized Multimedia Integration Language) was initially created by RealNetworks, Inc. to choreograph multimedia presentations of audio, video, text, and graphics in real-time. SMIL is a markup language for specifying how and when media clips play in a SMIL-enabled media player. SMIL was subsequently adopted as a standard by the World Wide Web Consortium (W3C). Several media players support the SMIL standard including RealPlayer, provided by RealNetworks (RealNetworks, Inc., Seattle, Wash.). The advantage of generating a multimedia presentation on the client is that if a portion of the multimedia presentation needs to be edited, such as a line of text, it is possible to edit only the text and not re-render or re-generate the entire video. This speeds up the editing process and decreases the cost of creating and maintaining multimedia content.

SAMI (Synchronized Accessible Media Interchange) was created by Microsoft (Microsoft Corporation, Bellevue, Wash.) to enable client-side captioning of digital media shown through a media player. SAMI captions are stored as text files, separate from the multimedia content. This enables captions to be easily modified, maintained, customized, and localized for different languages.

More recently, online video broadcasting services such as YouTube, and Yahoo!® Video have successfully attracted millions of users. These systems use the Adobe Flash media player from Adobe Systems of San Jose, Calif., to play videos that are stored in the FLV (Flash Video) encoding format on a central server. Recently Adobe introduced the FleX™ system that includes the ActiveScript 3 language for scripting the Flash Version 9 player. ActionScript 3 is used primarily for the development of website features and software that use the Flash Version 9 player.

### SUMMARY OF THE DESCRIPTION

The subject invention concerns a system and method for creating, storing, and serving a video ad in a smart media player that displays the ad in a standard Web browser. Using the subject invention, an advertiser can publish his or her video ad over the Web. Video ads can be viewed within conventional Web browsers that use smart media players, such as the Adobe Flash player. The Adobe Flash player is generally available on most platforms and Web browsers. As such, the subject invention does not require additional viewing software. The broadcaster, also referred to as an advertiser, creates a video ad using the subject invention and publishes the video ad on websites. Viewers can then select the multimedia video ads for viewing.

The subject invention is also particularly advantageous for advertisers who wish to customize aspects of a video ad for each viewer.

There is thus provided in accordance with an embodiment of the present invention a method for publishing video ads on Web pages, comprising providing a publisher interface for interactively specifying a video ad by a publisher wherein a video ad comprises one or more media clips and, optionally, one or more interactive controls, generating by the publisher interface a playlist that specifies the video ad wherein said playlist includes references to said one or more media clips and said optional interactive controls, storing by the publisher interface the playlist in a storage system, downloading the playlist from the storage system to a smart media player capable of processing said playlist, in response to a user request and playing the video ad by the smart media player.

There is additionally provided in accordance with an embodiment of the present invention a system for publishing video ads on Web pages, comprising a publisher interface for interactively specifying a video ad by a publisher wherein a video ad comprises one or more media clips and, optionally, one or more interactive controls, and generating a playlist that specifies the video ad wherein said playlist includes references to said one or more media clips and said optional interactive controls, a data storage for storing said playlist, a streamer for downloading the playlist from the storage system to a smart media player capable of processing said playlist, in response to a user request, and a smart media player for playing the video ad.

### BRIEF DESCRIPTION OF THE DRAWINGS

The best way to understand and appreciate the subject invention is in conjunction with the attached drawings. The drawings are summarized briefly below and then referred to in the Detailed Description that follows.

FIG. 1 is a simplified block diagram of a video ad system used by publishers to create, store, serve, and play video ads, in accordance with an embodiment of the subject invention;

FIG. 2A is an exemplary user interface of a video ad editor program used to create video ads, in accordance with an embodiment of the subject invention;

FIG. 2B is an exemplary user interface that illustrates publishing options available to a publisher when publishing a video ad, in accordance with an embodiment of the subject invention;

FIG. 2C is an exemplary user interface that illustrates syndication options available to a publisher when publishing a video ad, in accordance with an embodiment of the subject invention;

FIG. 2D is an exemplary user interface that illustrates an analytics dashboard that provides viewer playback statistics for a video ad, in accordance with an embodiment of the subject invention;

FIG. 3 is an exemplary user interface that illustrates a video ad displayed in a standard Web page, in accordance with an embodiment of the subject invention.

FIG. 4 is a simplified flow diagram depicting an overall method that enables a publisher to create a video ad, store a playlist and its component media clips on a video ad server, and serve the ad to a smart media player in response to a user request, in accordance with an embodiment of the present invention;

FIG. 5 is a simplified block diagram depicting the viewer client software architecture, in accordance with an embodiment of the subject invention;

FIG. 6 is a simplified transaction diagram depicting the exchange of data between a Web browser, Flash player, video ad player, and video ad server in response to a request for a video ad playback by a viewer, in accordance with an embodiment of the present invention;

FIG. 7 is a simplified block diagram depicting the software modules provided by a video ad server, in accordance with an embodiment of the subject invention; and

FIG. 8 is a simplified block diagram depicting an example hardware architecture for implementing a video ad server, in accordance with an embodiment of the present invention.

### DETAILED DESCRIPTION

The subject invention concerns video broadcasting and video advertising. Using the subject invention, a publisher can create, broadcast, and easily customize video content to the Web from his client computer. The rendering of sophisticated multimedia or video broadcasts is performed on the client computer by a smart media player, enabling videos to be customized in real-time following a playback request by a viewer.

As used herein the following terms have the meanings given below:

Viewer—means an individual that uses a client computer to view a video ad that appears in a Web browser.

Publisher—means an individual that prepares the video ad using a video ad editing program or “editor” and publishes the video ad to the Web.

Media file or media clip—means a computer file containing inter alia video, image sound, music, or graphics. A media clip may also contain a digital image that is displayed for a period of time.

Interactive element—means a user interface field in which the viewer may enter text or select from a list. Examples include multiple choice selections, data entry fields, radio buttons, and menus.

Playlist—means a computer file that describes how to combine or “render” inter alia media clips, text, background images or colors, and interactive elements to produce a video ad capable of being displayed inside a Web browser window.

Media player—means a software module that displays media within a Web page and operates in conjunction with a Web browser such as Microsoft Internet Explorer or Mozilla Firefox. Typically the Web media player displays the media inside a rectangular box in a Web page. Web media players include the Adobe Flash player, Microsoft Media Player, Apple Quicktime, and RealNetworks RealPlayer.

Smart media player—means a type of media player that is programmable, enabling the creator of a multimedia broadcast to specify a sequence of media clips, interactive elements, and text or sound overlays that will be rendered by the smart player and played. The Adobe Flash Version 9 player is an example of a smart media player.

Video advertisement (henceforth referred to as a video ad)—means a video or multimedia presentation that results when a smart media player renders a playlist to a Web browser window. A video ad includes one or more media clips and digital images, digital sound files including digital music, and text, and interactive elements which are combined to produce a video stream capable of being displayed on a web browser. As used herein, the playlist and component media clips are streamed across a network such as the Internet to a smart media player which renders the video ad into a window in a Web browser. In one embodiment, a playlist is in XML format. Alternatively, a playlist may be in a proprietary binary or text format.

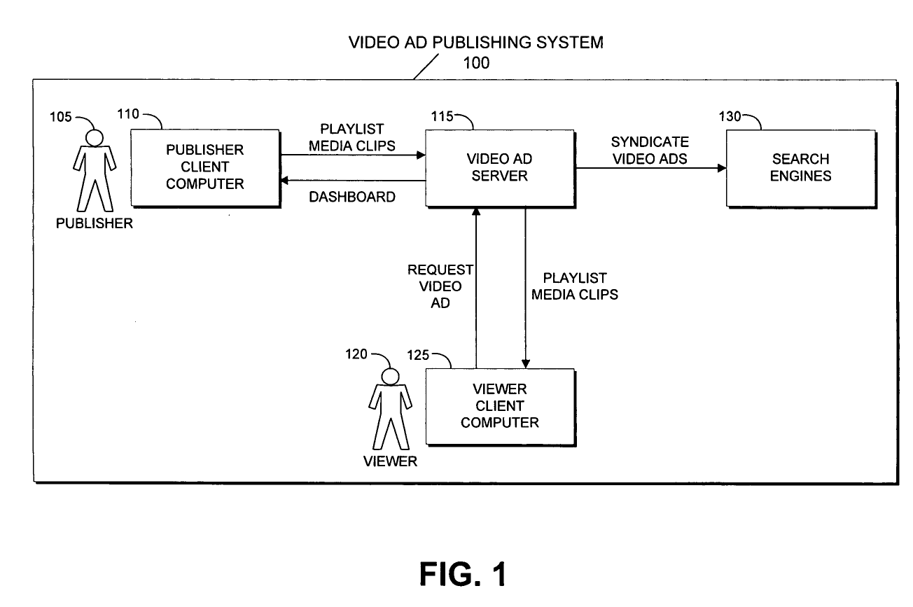

It may be appreciated that a video ad is not restricted to being a commercial advertisement. A video ad may be inter alia a documentary, a music video, a news broadcast, a business presentation, or a sequence of personal video clips. The term video ad is therefore employed because the overall video ad system, described in further detail with respect to FIG. 1 has unique advantages for the creation and publishing of video advertisements but nothing about the present invention limits the subject matter or intended usage of a video ad to commercial advertising.

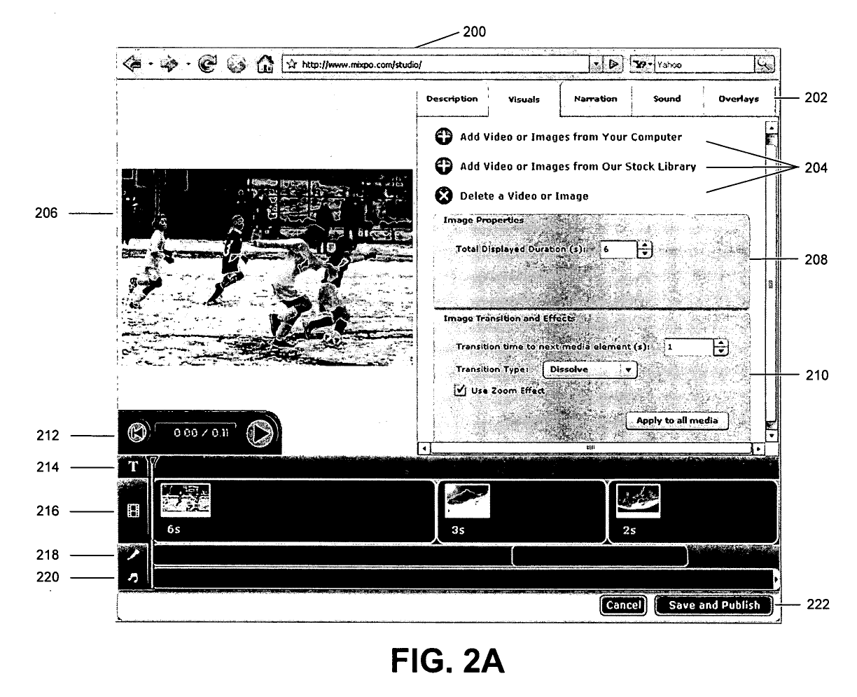

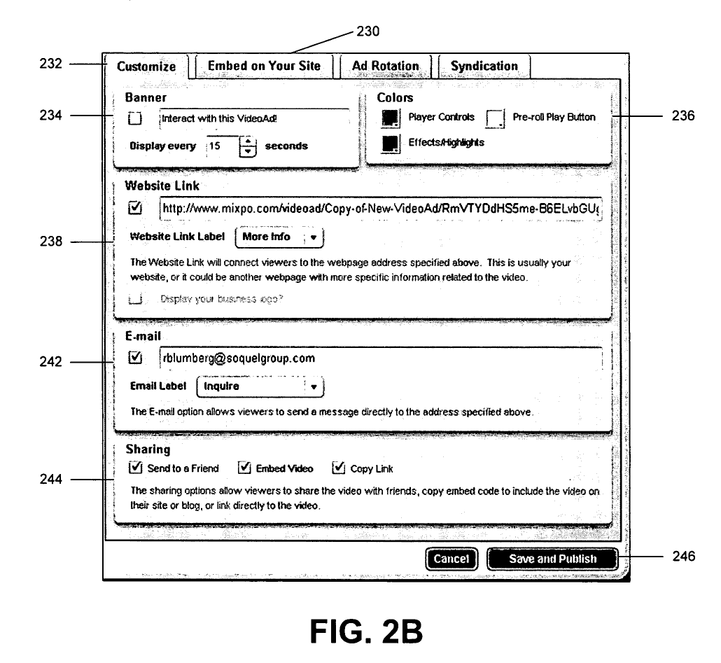

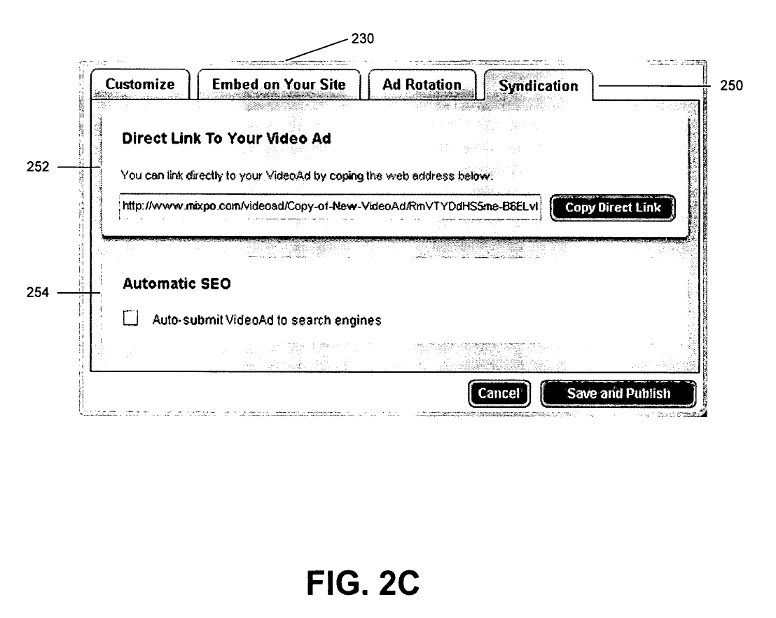

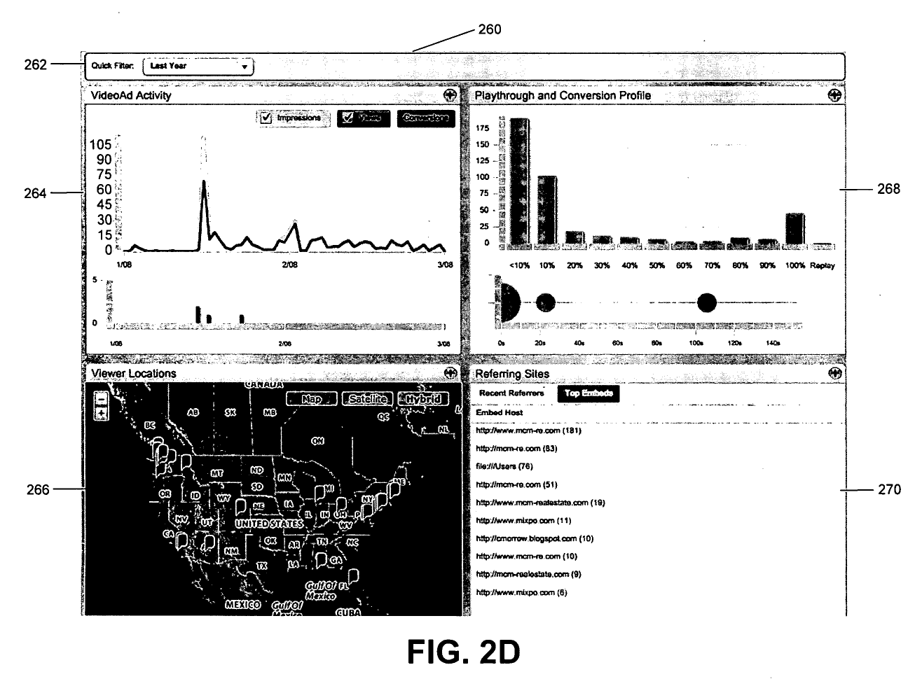

Reference is now made to FIG. 1, which is a simplified block diagram of a video ad system used by publishers to create, store, serve and play video ads, in accordance with an embodiment of the subject invention. Shown in FIG. 1 is a video ad publishing system 100 that enables content providers, referred to as publishers, to broadcast media over the Web. A publisher 105 creates a video ad using a video ad editing program, also referred simply as an “editor”, that runs on a publisher client computer 110. The editor creates a playlist that includes the instructions for rendering separately stored media clips together with information such as text overlays and timing to create and play a video ad. The editor is described in greater detail with respect to FIGS. 2A-2C. When publisher 105 completes creating the video ad he/she “publishes” the video ad to a video ad server 115. This step of the publishing process consists of uploading the playlist together with any media clips referenced in the playlist to video ad server 115. Video ad server 115 then performs additional processing steps which result in the video ad being available for viewing by a viewer 120 from a viewer client computer 125. At the option of publisher 105, video ad server 115 syndicates the video ad to a number of video search engines 130. Syndication of video ads is described in further detail with respect to FIG. 2C.

Reference is now made to FIG. 2A, which is an exemplary user interface of a video ad editor program used to create and publish video ads, in accordance with an embodiment of the subject invention. In the embodiment depicted in FIGS. 2A-2C, the editor is a Web program that can be implemented inter alia as an Adobe Flex (Flash) program that runs in the Web browser's Flash player. Similarly, an analytics dashboard described with reference to FIG. 2D is a Web program that can be implemented inter alia as a Flex (Flash) program that runs in a Web browser's Flash player. The editor initially displays user interface 200 which enables publisher 105 to create, store on video ad server 105, and publish a video ad. A series of media tabs 202 enable publisher 105 to provide a description of the video ad, specify visuals which include one or more digital images and/or digital videos, record or select one or more audio narration files, select one or more sound files, and specify one or more text overlays.

The Visuals tab from media tabs 202 provides file controls 204 that enable publisher 105 to add a video or images inter alia from the publisher's client computer, from another video ad in the publisher's account, or from images in a stock library. File controls 204 further enable publisher 105 to delete a video or image. Publisher 105 uses an image properties control 208 to specify the duration of the video clip or image. Publisher 105 uses a set of image transition and effects controls 210 to specify the transition time in seconds between adjacent media elements (also referred to as media clips), to select a transition type from a menu of effects, and to specify whether to use a zoom effect. Publisher 105 may optionally apply the settings from image transition and effects controls to all media clips.

Publisher 105 can preview the video ad using a set of preview controls 212. A series of preview controls 212 enable publisher 105 to preview how the video ad will appear when played in a browser window. At the bottom of user interface 200, a series of timeline controls enable publisher 105 to select and edit: text elements (control 214), image and video clip properties (control 216), narration clips, and music clip properties (control 220). Finally, a publish control 222 enables publisher 105 to save and publish the video ad or to cancel and not save any edits made.

Reference is now made to FIG. 2B, which is an exemplary user interface that illustrates publishing options available to a publisher when publishing a video ad, in accordance with an embodiment of the subject invention. A publishing options dialog box 230 offers a series of publishing options tabs 232 that enable publisher 105 to customize aspects of the video ad, embed the video ad on a website, define ad rotation options, and specify syndication options. In the example user interface, a customize tab is active. A set of banner controls 234 enable publisher 105 to display or hide and customize the label for a banner that draws viewers' attention to the built-in calls to action. A set of color controls 236 enable publisher 105 to specify the color and effects/highlights of the media player controls and calls to action and the color of the pre-roll play button.

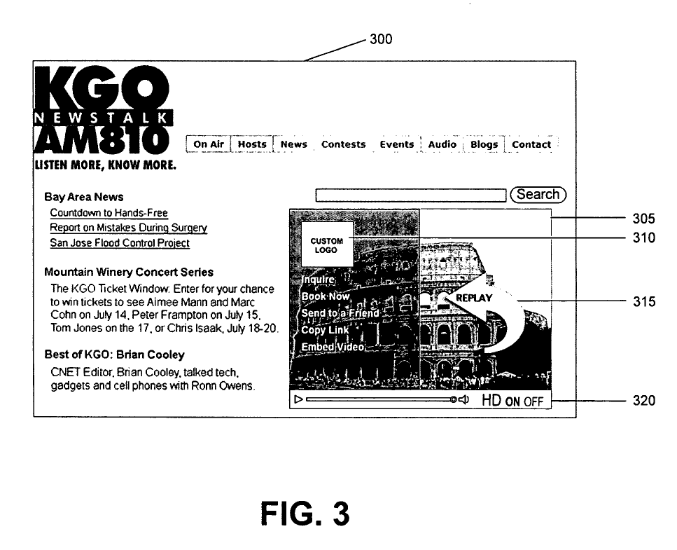

A set of website link controls 238 allows publisher 105 to specify the Uniform Resource Locator (URL) for a Web page to be displayed for viewers who click a More Info call to action that is consequently embedded in the video ad. Typically, the Web page shown when a view clicks a More Info call to action enables viewers to learn more about the company and products of publisher 105. Website link controls 238 further enable publisher 105 to customize the label of the More Info call to action. An example of a More Info call to action is illustrated in FIG. 3.

A set of email controls 242 allows publisher 105 to specify the email address associated with an Inquire call to action. When viewer 120 clicks Inquire, a form opens that allows viewer 120 to send an inquire email message to publisher 105. If publisher 105 does not want to include an Inquire call to action, he/she can uncheck the box. Email controls 242 further enable publisher 105 to customize the label for the Inquire call to action.

A set of sharing controls 244 allow publisher 105 to include any of the Send to a Friend, Embed Video, and Copy Link calls to action with the video ad. When viewers 120 click Send to a Friend, a form opens that allows viewers to send a link to the video ad to a number of friends. When viewers 120 click Embed Video, a form opens that provides them with code they can copy and paste to include the video ad in their own Web sites. When viewers 120 click Copy Link, a form opens that allows them to easily copy a link to the video ad that they can paste into pages on their own site or send through email.

Finally, a publish control 246 enables publisher 105 to save the publishing options along with the video ad and to publish the video ad, or to cancel and not save the publishing option selections.

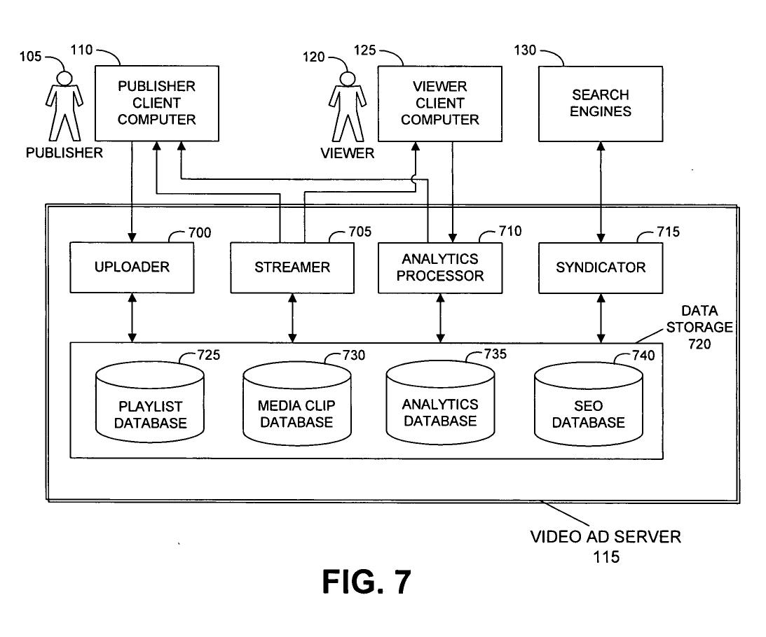

Reference is now made to FIG. 2C, which is an exemplary user interface that illustrates syndication options available to a publisher when publishing a video ad, in accordance with an embodiment of the subject invention. FIG. 2C illustrates the syndication options available from a syndication tab 250 available from publishing options dialog box 230 described with reference to FIG. 2B. A video ad link control 252 provides a link to the video ad stored on video ad server 115. Video ad link control 252 enables publisher 105 to copy the Internet address, commonly referred to as a Uniform Resource Locator or “URL”, of the video ad and then paste it into an email or a Web page where he/she wishes to display a link to the video ad. An automatic SEO control 254 enables publisher 105 to specify whether he/she wants video ad server 115 to automatically submit the video ad to search engines. If publisher 105 selects the auto-submit feature, then video ad server 254 provides information about the video ad to a plurality of search engines that offer specific methods for indexing videos including inter alia AOL Video, Yahoo Video and Google Video. The steps performed by video ad server 115 to auto-submit the video ad are described in further detail with respect to FIG. 7.

Reference is now made to FIG. 2D, which is an exemplary user interface that illustrates an analytics dashboard that provides viewer playback statistics for a video ad, in accordance with an embodiment of the subject invention. An analytics dashboard 260 enables publisher 105 to view usage statistics for each video ad that he/she has published either individually, or in any combination. Publisher 105 may use a quick filter 262 to select a time period for the statistics presented by dashboard 260. Dashboard 260 presents four example panels, a video ad activity panel 264, a viewer locations panel 266, a playthrough and conversion profile panel 268, and a referring sites panel 270.

Video ad activity panel 264 presents the number of impressions, views, and conversions for a video ad for the selected time period. A view is when a viewer explicitly requests to view a video ad, or when the video ad is embedded in a Web page in auto-play mode and is served to a viewer. In auto-play mode, the video ad commences playing when the video ad appears; viewer 120 doesn't have to explicitly request playback. In this example user interface, the impressions and views are presented in the top graph and conversions are presented in the lower graph.

Viewer locations panel 266 presents the geographic location of each viewer of the video ad. The IP address of the requesting Web browser is converted to a latitude and longitude using lookup tables which provide estimated latitude/longitude information for almost any IP address. In this example user interface, the locations are superimposed on top of a map. Typically, the map is generated in real-time by a call to a web-based mapping service such as Google™ Maps or Yahoo! Maps. In the preferred embodiment, the map is provided and the location of each viewer 120 is plotted using an Actionscript 3.0 API provided by Yahoo! Maps. The Yahoo! Maps web service is provided by Yahoo!, Inc. of Mountain View, Calif.

Playthrough and conversion profile panel 268 displays how long viewers watched a video ad, as a percentage of the total length of the video ad during the selected period. For example, over one hundred seventy five (175) viewers played less than 10% of the video ad, while roughly forty (40) viewers played the entire video ad. Playthrough and conversion profile panel 268 also shows the number of viewers that engaged in a conversion. A conversion is defined as a viewer clicking on the “more info” control displayed by the media player, sending an email to the publisher via an “inquire” button, clicking on a text overlay during playback, or filing out a lead capture form during playback. Conversion statistics provide insight into the effectiveness of video ads.

Referring sites panel 270 lists the websites that viewers 120 were viewing immediately prior to viewing the video ad. For each website listed, the domain URL together with the number of viewers that came from the domain is given. Selecting a “Top Embeds” control that appears in referring sites panel 270 lists the various websites that host the video ad, i.e. the websites where the video ad appears on the Web, and the number of times the video ad was viewed on each website.

Reference is now made to FIG. 3, which is an exemplary user interface that illustrates a video ad displayed in a standard Web page, in accordance with an embodiment of the subject invention. As depicted in FIG. 3, a standard Web page 300 includes a video ad 305. Video ad 305 displays a More Info call to action 310, as previously described with reference to FIG. 2B. In this example, More Info call to action 310 displays a message that reads “Custom Logo” indicating that an advertiser may place their company logo in the indicated position. A replay control 315 enables viewer 120 to replay the video ad after is completes. A group of play controls 320 enable viewer 120 to pause/play the video ad, view progress and turn on or turn off the audio associated with the video ad.

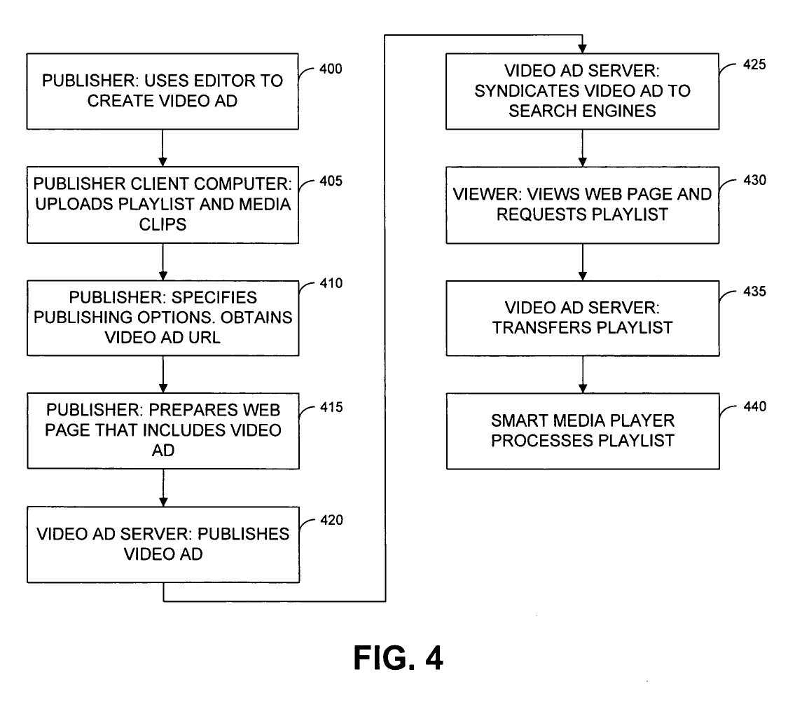

Reference is now made to FIG. 4, which is a simplified flow diagram depicting an overall method that enables a publisher to create a video ad, store a playlist and its component media clips on a video ad server, and serve the ad to a smart media player in response to a user request, in accordance with an embodiment of the present invention. At step 400 publisher 105 uses the editor, previously described with reference to FIG. 2A, to create a video ad. After creating the video ad, at step 405, the editor, running on publisher client computer 110, generates a playlist and uploads the playlist to video ad server 115 to be published. In this embodiment, all media clips are uploaded to video ad server 115 along with the playlist. In another embodiment, only selected media clips are uploaded. Because the playlist contains a reference to each media clip and does not include the media data itself, it is possible for a media clip to reside at any location on the Internet accessible by a URL.

An example playlist is provided in Listing 1. The example playlist describes a video ad that contains ten images, two video clips, two audio files, and one text overlay. For each image, four different size representations are listed. For each video clip, two different bit rate representations are listed together with multiple thumbnail images extracted from the video clip. The text overlay media type includes the description and appearance of the text overlay as well as the action tied to the overlay, in this example a click-through URL. In this example playlist each media element has the same one-second “dissolve” transition.

At step 410 the editor displays publishing options dialog box 230 that enables publisher 105 to specify publishing options including options to customize the video ad, embed the video ad in a Web page, perform ad rotation, and syndicate the video ad to search engines. The customize tab of publishing options dialog box 230 presents a URL to the video ad on video ad server 115 that publisher 105.

At step 415, publisher 105 prepares a Web page that includes the video ad. This may be a static HTML Web page or a dynamic Web page that is generated automatically. Publisher 105 copies the video ad embed code provided in the customize tab of publishing options dialog box 230 into the HTML Web page. At step 420 video ad server 115 performs the processing required to make video ad available for viewing by viewer 120. At step 425, if publisher 105 has requested that video ad server submit the video ad to search engines using automatic SEO control 254 then video ad server 115 submits the video ad to a plurality of search engines. The processing performed by video ad server to submit a video ad to search engines is described in further detail with respect to FIG. 7.

At step 430 viewer 120 visits a Web page that displays the video ad and requests playback of the video ad. Typically, the first frame of a video ad is displayed in a rectangular window in the Web page and viewer 120 uses a play control also displayed in the rectangular window to request playback. Typically, in response to the user action the Web browser executes an HTML request to download from video ad server 115 the playlist which corresponds to the desired video ad. The Web browser also invokes, i.e. runs, the smart media player which is capable of processing the playlist and thereby playing the video ad. At step 435, video ad server 115 transfers the playlist corresponding to the video ad to the Web browser. At step 440, the smart media player that has been invoked by the Web browser running in client computer 125 processes sequentially each instruction in the playlist thereby playing the video ad. During playback by the smart browser, viewer 120 may use playback controls provided by the smart browser to control playing. Such playback controls may include stop, pause, start, start over, fast forward, backward. During playback, the smart media player will request any media clips referenced in the playlist from video ad server 115.

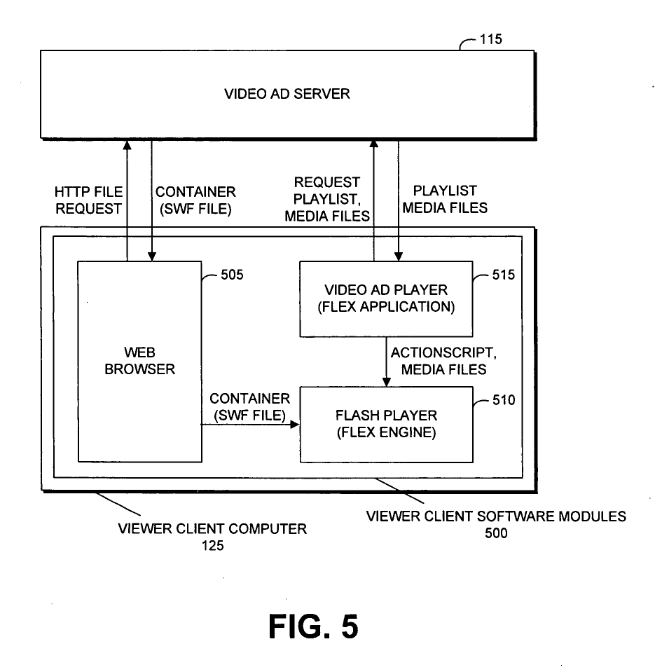

Reference is now made to FIG. 5, which is a simplified block diagram depicting the viewer client software, in accordance with an embodiment of the subject invention. A set of viewer client software modules 500 run in viewer client computer 125. In the preferred embodiment described now with reference to FIG. 5, the smart media player used to process a playlist is an Adobe Flash player 510 provided by Adobe Systems Inc. Version 9 or above of Flash player 510 is preferred. Thus, certain aspects of the software described with reference to FIG. 5 are specific to the use of Flash player 510. However, a comparable architecture can be used for other smart media players, e.g. the Microsoft Windows Media Player provided by the Microsoft Corporation. Flash player 510 runs in conjunction with a Web browser 505 as an Active X control or a plug-in depending on which Web browser is called. For example, if Web browser 505 is Microsoft Internet Explorer than typically Flash player 510 runs as an Active X control. Active X is a format defined by the Microsoft Corporation, Redmond, Wash. If Web browser 505 is Mozilla Firefox, then Flash player 510 runs as a Firefox plug-in or extension as defined by Mozilla of Mountain View, Calif.

Flash player 510 operates as a “virtual machine,” commonly referred to as a “flex engine,” that processes a programming language referred to as ActionScript. ActionScript is defined and maintained by Adobe Systems, Inc. An ActionScript application defines the behavior of a Flash player. In addition, Flash player 510 processes a script language named SWF. A video ad player 515, which is an ActionScript program, or flex application, processes playlists, stored in video ad server 115 and generates ActionScript code that is executed by FlashPlayer 510. The ActionScript generated by video ad player 515 enables Flash player 510 to correctly process the playlist in the native language, ActionScript, of Flash player 510.

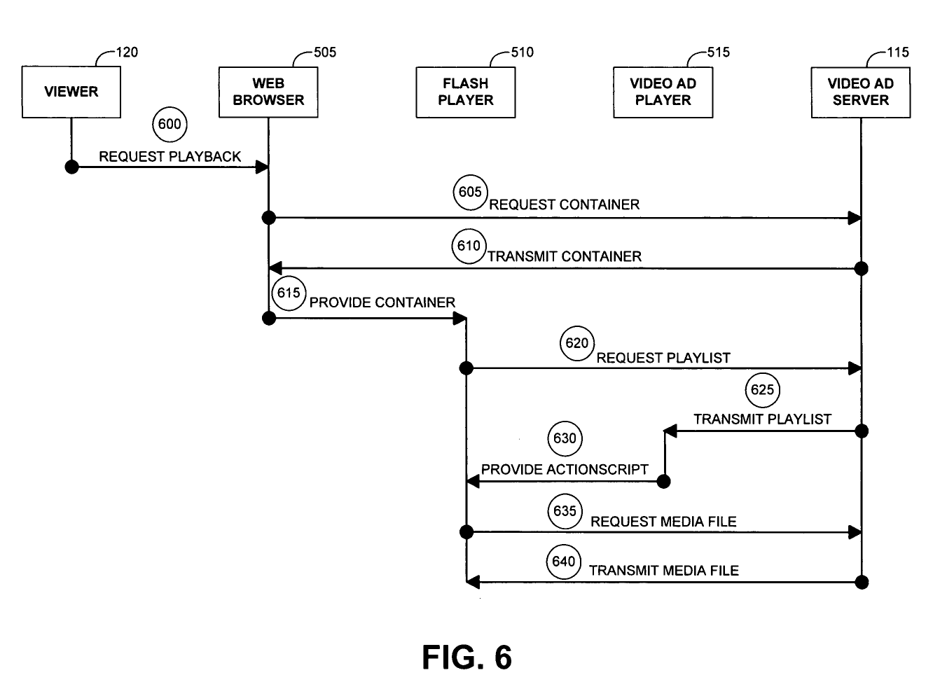

Reference is now made to FIG. 6, which is a simplified transaction diagram depicting the exchange of data between a Web browser, Flash player, video ad player, and video ad server in response to a request for a video ad playback by a viewer, in accordance with an embodiment of the present invention. In the preferred embodiment described now with reference to FIG. 6, the smart media player used to process a playlist is Flash player 510. At step 600 viewer 120 requests playback of a video ad. Typically the first frame of the video ad appears in a rectangular window in a Web page that he/she is viewing where the video ad will be played. Viewer 120 requests playback by clicking on the rectangular window or by clicking a play control that appears in the rectangular window. Web browser 505 responds to the playback request at step 605 by sending a request for a container file to video ad server 115. An example of the HTML code that generates the request is given below. In the example, the HTML code for the “embed command” first defines a Flash player object, which will operate in a 400 pixel width by 300 pixel high window. The embed command also includes an instruction to run Flash player 510 in the Web page. As the initial operating instructions to the Flash player 510, a file named main.swf is downloaded from video ad server 115. The embed command code for this example is given below:

### Example HTML Code for Embedding Video Ad System Player:

<embed src=“http://www.mixpo.com/player/main.swf” quality=“high”
bgcolor=“#000000” width=“400” height=“300” name=“mixpo_player”
align=“middle” play=“true” loop=“false” quality=“high”
allowScriptAccess=“always”
allowFullScreen=“true” flashvars=“guid=8583e7bb-4d30-4862-9239-
c1259adf6006&environment=&host=www.mixpo.com&forcePlay=
false&autoPlay=false
&autoPlayAudio=true” type=“application/x-shockwave-flash”
pluginspage=“http://www.adobe.com/go/getflashplayer”> </embed>

At step 610 video ad server 115 transmits the container file, main.swf to requesting Web browser 505. At step 615 Web browser 505 runs the Flash player and provides it with the container file. Main.swf constitutes the initial operating instructions for Flash player 510. Main.swf is referred to as a container file because it contains instructions that define aspects of the player but does not include the video ad content itself. For example, main.swf defines visual characteristics of the player, such as its core functionality and which control buttons appear on the screen. Main.swf also contains instructions to request and download the playlist that defines the video ad content. These include the GUID which uniquely references the playlist on video ad server 115. Then, at step 620 video ad player 515 requests the playlist associated with the GUID.

At step 625 video ad server 115 transmits the playlist. At step 630 video ad player 515 reads the playlist and at step 630 generates appropriate ActionScript code to enable Flash player 510 to render the playlist using playback functionality provided by the Flash player 510 engine, thus playing the video ad in the defined rectangle within the currently displayed HTML Web page. Since the playlist references but doesn't include media clips, video ad player 515 must request each media file from video ad server 115. Thus, step 635, requesting a media file by video ad player 515, and step 640, transmitting a media file by video ad server 115, are repeated for each media file referenced in the playlist.

Reference is now made to FIG. 7, which is a simplified block diagram of a video ad server, in accordance with an embodiment of the subject invention. After publisher 105 creates a video ad and specifies its publishing options, an uploader 700 uploads the playlist and stores it in a playlist database 725. Uploader 700 also uploads any corresponding media clips and stores them in a media clip database 730. Typically, uploader 700 uses the hypertext transfer protocol (HTTP) to upload files including a playlist and media clips. HTTP is a network protocol used to transfer data from one computer to another through a network, such as over the Internet. HTTP is standardized by the Worldwide Web Consortium (http://www.w3.org/).

A streamer 705 responds to requests to transmit playlists and media clips. Publisher client computer 110 requests playlists and media clips when publisher 105 edits or reviews video ads. Viewer client computer 125 requests playlists and media clips when viewer 120 requests playback of video ads. Streamer 705 responds to file transfer requests using the HTTP file transfer method.

An analytics processor 710 collects viewing statistics from viewer client computer 125 and stores the data in an analytics database 735. Upon request from publisher client computer 110, analytics processor analyzes the stored statistic and provides analytic information that is displayed in an analytics dashboard, previously described with reference to FIG. 2D.

A syndicator 715 performs video search engine optimization, commonly referred to as video SEO, for each video ad for which publisher 105 has requested automatic submission as described with reference to FIG. 2C. Video SEO refers to a number of methods whose goal is to ensure that a video attracts as much traffic as possible. Syndicator 715 automatically submits each newly published video ad to leading search engines that index videos including inter alia Google Video Search, Yahoo! Video, and AOL® Video.

Syndicator 715 submits a video ad to a search engine using a method defined by the search engine. This ensures that the search engine lists the video ad among the search engine results and provides accurate information concerning the video ad. For example, in order to submit a video ad to the Truveo.com video search engine that indexes videos hosted by other sites, syndicator 715 creates a media RSS feed upon request, commonly referred to as an mRSS, and makes it available to Truveo electronically through a previously established “Director Account.” Once a mRSS feed is submitted, a Truveo crawler retrieves the feed periodically throughout each day, verifies the video ads, indexes the metadata included with the video ads, and integrates the video ads into a Truveo video search index which enables searching of videos. Each video ad included in the Truveo video search index can be discovered through search using an ordinary Web browser. When the video ad appears in a search result set Truveo provides some relevant metadata (title, description, format, etc.) and a thumbnail image representing the video ad. When a user clicks on the video in the Truveo results page, they are directed to a Web page that includes the video ad. Truveo is a company owned by AOL, Inc. Further information concerning Truveo may be found at http://developer.truveo.com/.

Syndicator 715 performs comparable methods to that described above to syndicate video ads to a plurality of search engines. For example, Syndicator 715 uses a method, referred to as video sitemaps, to publish and syndicate video ads to the Google Video search engine.

For each video ad, syndicator 715 creates a static Web page. This ensures that for each video ad submitted there is a fixed URL that can be submitted to search engines such that the search engines can periodically crawl the static Web page to verify that it indeed exists. Further, the static Web page for the video ad includes descriptive metadata including inter alia a title, thumbnails from the different media elements in the playlist, and business information regarding publisher 105 that will ensure that the video ad is accurately and thoroughly indexed by search engines.

Syndicator 715 stores information required to perform different syndication methods as well as a static Web page for each video ad in search engine optimization (SEO) database 740.

Data storage 715 includes a relational database management system (RDBMS), three relational databases as previously discussed, and a physical storage system. The physical storage system includes online disk storage and backup storage. In addition, the physical storage system may include a remote, hosted, storage system, such as the S3 storage system provided by Amazon, Inc. of Seattle, Wash. In one embodiment, the three databases, playlist database 720, media clip database 725, and SEO database 730 are stored centrally on one or more disk storage systems. In an alternative embodiment, media clips are stored in remote, hosted storage while playlist database 720 and SEO database 730 are stored centrally. In a further embodiment, media clips are stored in a content delivery network (CDN). A CDN is a system of computers networked together across the Internet that cooperate transparently to deliver content (especially large media files) to end users. CDN storage is provided by a number of companies including Akamai Technologies, Inc. of Cambridge, Mass., and Digital Island owned by Cable and Wireless of the United Kingdom.

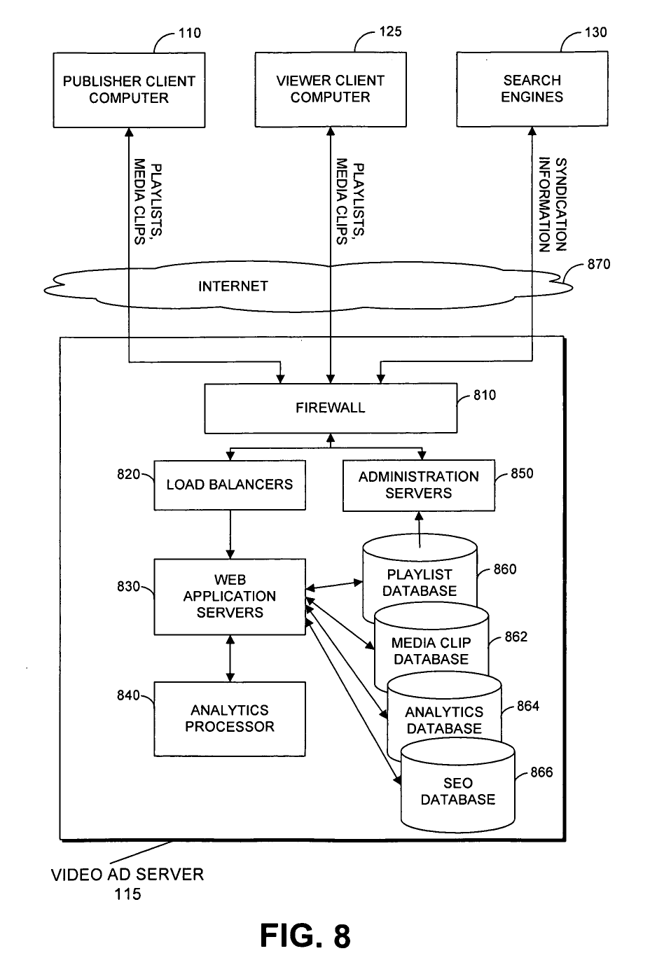

It will be appreciated by those skilled in the art that the systems and methods of the present invention may be implemented within a variety of client-server hardware and network architectures. In this regard, reference is now made to FIG. 8, which is a simplified block diagram depicting an example hardware architecture for implementing a video ad server, in accordance with an embodiment of the present invention. On the server side, the architecture in FIG. 8 includes a firewall 810, one or more Web application servers 830 managed by load balancers 820, one or more administration servers 850, an analytics processor 840 computer system, and four databases. The databases include a playlist database 860 for storing playlists, including the data from playlist database 720 shown in FIG. 7, a media clip database 862 for storing media clips, including the data from media clip database 730, an analytics database 864 for storing statistics and analytics information including the data from analytics database 735, and a SEO database 866 for storing SEO information and static Web pages, including the data from SEO database 740. It will be appreciated by those skilled in the art that FIG. 8. refers to physical database storage systems, while the databases in FIG. 7 refer to the data files that comprise a database, which may be implemented by a wide range of physical storage architectures. Web application servers 830 manage analytics processor 840, playlist database 860, media clip database 862, analytics database 864, and SEO database 866. All of these server components are subsumed in video ad server 115.

On the client side, the architecture in FIG. 8 includes publisher client computer 110, viewer client computer 125, and search engines 130. Publisher client computer 110 has a two-way connection with load balancers 820 for uploading and downloading playlists and media clips. Viewer client computer 125 has a two-way connection with load balancers 820 for downloading playlists and media clips and for uploading viewing statistics. Search engines 130 have two-way connections with load balancers 820 for receiving video ad syndication data and performing a syndication data protocol.

In reading the above description, persons skilled in the art will realize that there are many apparent variations that can be applied to the methods and systems described.

LISTING 1: Example Playlist

```
<container domain=“MX” duration=“79134” sessionid=“fTe-Z3O6QoQflB5PTu8T9A**”
friendlyurl=“http://www.mixpo.com/videoad/Example-
VideoAd/PbJI3DltQv6HyLc_5TAqiA” guid=“3db248dc-396d-42fe-87c8-b73fe5302a88”
logoguid=“5d6fb000-8ffe-4fa7-9534-d1756da81c94_LOGO” syndicated=“false”
title=“Example VideoAd” userkey=“5d6fb000-8ffe-4fa7-9534-d1756da81c94”
status=“A” version=“1.1”>
-
<useractions>
<useraction type=“emailcustomer”/>
<useraction type=“redirect” value=“http://www.mixpo.com/”/>
<useraction type=“play”/>
<useraction type=“impression”/>
<useraction type=“emailpublisher” value=“contact_email@mixpo.com”/>
<useraction type=“emailfriend”/>
<useraction type=“embedcode”/>
<useraction type=“copylink”/>
</useractions>
-
  <mediamanifest containerguid=“3db248dc-396d-42fe-87c8-b73fe5302a88”
friendlyurl=“http://www.mixpo.com/videoad/Example-
VideoAd/PbJI3DltQv6HyLc_5TAqiA” title=“Example VideoAd” version=“1.1”>
-
  <media domain=“MX” filename=“DSC01172” guid=“03e119dd-4e00-4a59-8ddf-
33887542c167” type=“image/jpeg” userkey=“5d6fb000-8ffe-4fa7-9534-
d1756da81c94”>
<representation filesize=“30764”>JPG1024</representation>
<representation filesize=“2872”>JPG128</representation>
<representation filesize=“11253”>JPG320</representation>
<representation filesize=“30764”>JPG640</representation>
</media>
-
  <media domain=“MX” filename=“IMG_1126” guid=“0778ec84-35d8-45bb-a4d0-
e69d084638de” type=“image/jpeg” userkey=“5d6fb000-8ffe-4fa7-9534-
d1756da81c94”>
<representation filesize=“122782”>JPG1024</representation>
<representation filesize=“3639”>JPG128</representation>
<representation filesize=“14059”>JPG320</representation>
<representation filesize=“46887”>JPG640</representation>
</media>
-
  <media domain=“MX” filename=“193_9371” guid=“131780e9-158b-4234-bb8f-
d3e832cf8d58” type=“image/jpeg” userkey=“5d6fb000-8ffe-4fa7-9534-
d1756da81c94”>
<representation filesize=“95047”>JPG1024</representation>
<representation filesize=“3080”>JPG128</representation>
<representation filesize=“12833”>JPG320</representation>
<representation filesize=“41341”>JPG640</representation>
</media>
-
  <media domain=“MX” filename=“DSC04002” guid=“14c8f811-1a21-4ac7-bfc8-
ffe95de304da” type=“image/jpeg” userkey=“5d6fb000-8ffe-4fa7-9534-
d1756da81c94”>
<representation filesize=“47951”>JPG1024</representation>
<representation filesize=“3694”>JPG128</representation>
<representation filesize=“15814”>JPG320</representation>
<representation filesize=“47951”>JPG640</representation>
</media>
-
  <media domain=“MX” filename=“retreat15” guid=“3365d57a-3215-4015-a78b-
668310f6a3d6” type=“image/jpeg” userkey=“5d6fb000-8ffe-4fa7-9534-
d1756da81c94”>
<representation filesize=“167056”>JPG1024</representation>
<representation filesize=“4133”>JPG128</representation>
<representation filesize=“21260”>JPG320</representation>
<representation filesize=“74337”>JPG640</representation>
</media>
-
  <media domain=“MX” duration=“25634” filename=“City/1
Crowds/Barcelona_Market.mp3” guid=“44de2b89-782f-4710-9527-b000a2faa341”
stockcode=“roy” type=“audio/mpeg” userkey=“smm”>
<representation filesize=“205009”>MP3</representation>
</media>
-
  <media domain=“MX” filename=“39230967.IMG_1219” guid=“703d5b96-ff56-4c11-
ab38-66e93e521b0c” type=“image/jpeg” userkey=“5d6fb000-8ffe-4fa7-9534-
d1756da81c94”>
<representation filesize=“91812”>JPG1024</representation>
<representation filesize=“4925”>JPG128</representation>
<representation filesize=“21479”>JPG320</representation>
<representation filesize=“66780”>JPG640</representation>
</media>
-
  <media domain=“MX” filename=“Ptarm010” guid=“a0677d5c-dd45-415d-939a-
60c408b02f19” type=“image/jpeg” userkey=“5d6fb000-8ffe-4fa7-9534-
d1756da81c94”>
<representation filesize=“115609”>JPG1024</representation>
<representation filesize=“3772”>JPG128</representation>
<representation filesize=“16872”>JPG320</representation>
<representation filesize=“52733”>JPG640</representation>
</media>
-
  <media domain=“MX” filename=“MVI_1544” guid=“b22c6e4d-37f7-4294-ba95-
093e885a041b” type=“video/x-flv” userkey=“5d6fb000-8ffe-4fa7-9534-
d1756da81c94”>
<representation filesize=“1263984”>FLV320</representation>
<representation filesize=“3396329”>FLV640</representation>
<representation filesize=“78567”>JPG1024</representation>
<representation filesize=“4776”>JPG128</representation>
<representation filesize=“3572”>JPG128_1</representation>
<representation filesize=“4940”>JPG128_10</representation>
<representation filesize=“4940”>JPG128_11</representation>
<representation filesize=“3887”>JPG128_12</representation>
<representation filesize=“3458”>JPG128_2</representation>
<representation filesize=“2698”>JPG128_3</representation>
<representation filesize=“4025”>JPG128_4</representation>
<representation filesize=“4523”>JPG128_5</representation>
<representation filesize=“4951”>JPG128_6</representation>
<representation filesize=“5435”>JPG128_7</representation>
<representation filesize=“3489”>JPG128_8</representation>
<representation filesize=“4138”>JPG128_9</representation>
<representation filesize=“24688”>JPG320</representation>
<representation filesize=“78567”>JPG640</representation>
</media>
-
  <media domain=“MX” filename=“IMG_8117” guid=“bffdf594-9e42-4d1d-a5e7-
334ddf4462ac” type=“image/jpeg” userkey=“5d6fb000-8ffe-4fa7-9534-
d1756da81c94”>
<representation filesize=“118826”>JPG1024</representation>
<representation filesize=“4028”>JPG128</representation>
<representation filesize=“16528”>JPG320</representation>
<representation filesize=“52473”>JPG640</representation>
</media>
-
  <media domain=“MX” filename=“IMG_7115” guid=“c6bba46d-2bd1-484d-8304-
875f4435ceef” type=“image/jpeg” userkey=“5d6fb000-8ffe-4fa7-9534-
d1756da81c94”>
<representation filesize=“94239”>JPG1024</representation>
<representation filesize=“4449”>JPG128</representation>
<representation filesize=“17401”>JPG320</representation>
<representation filesize=“46538”>JPG640</representation>
</media>
-
  <media domain=“MX” duration=“31475” filename=“Positive Music
Transcodes/1000_Miles/1000_Miles_Loop_A.mp3” guid=“d3939564-042a-4a2a-a0aa-
3c3a04ba157c” stockcode=“upbeat” type=“audio/mpeg” userkey=“smm”>
<representation filesize=“251821 ”>MP3</representation>
</media>
-
  <media domain=“MX” filename=“006_sawtooth_steeleman” guid=“daab28c5-a684-
42a2-ba5c-e38d9031ffc8” type=“image/jpeg” userkey=“5d6fb000-8ffe-4fa7-9534-
d1756da81c94”>
<representation filesize=“43632”>JPG1024</representation>
<representation filesize=“3270”>JPG128</representation>
<representation filesize=“14313”>JPG320</representation>
<representation filesize=“43632”>JPG640</representation>
</media>
-
  <media domain=“MX” filename=“MVI_1300” guid=“ee61ca9b-ce4e-4191-8fd1-
b2c5282a287b” type=“video/x-flv” userkey=“5d6fb000-8ffe-4fa7-9534-
d1756da81c94”>
<representation filesize=“475250”>FLV320</representation>
<representation filesize=“1306291”>FLV640</representation>
<representation filesize=“50516”>JPG1024</representation>
<representation filesize=“3713”>JPG128</representation>
<representation filesize=“1953”>JPG128_1</representation>
<representation filesize=“2387”>JPG128_10</representation>
<representation filesize=“2387”>JPG128_11</representation>
<representation filesize=“1893”>JPG128_12</representation>
<representation filesize=“2232”>JPG128_2</representation>
<representation filesize=“2477”>JPG128_3</representation>
<representation filesize=“2366”>JPG128_4</representation>
<representation filesize=“2227”>JPG128_5</representation>
<representation filesize=“2285”>JPG128_6</representation>
<representation filesize=“2387”>JPG128_7</representation>
<representation filesize=“2387”>JPG128_8</representation>
<representation filesize=“2387”>JPG128_9</representation>
<representation filesize=“15282”>JPG320</representation>
<representation filesize=“50516”>JPG640</representation>
</media>
</mediamanifest>
-
  <visualtimeline>
<slide duration=“4000” guid=“3365d57a-3215-4015-a78b-668310f6a3d6”
transitionin=“dissolve” transitioninduration=“1000”/>
<slide duration=“28967” guid=“b22c6e4d-37f7-4294-ba95-093e885a041b”
transitionin=“dissolve” transitioninduration=“1000”/>
<slide duration=“4000” guid=“a0677d5c-dd45-415d-939a-60c408b02f19”
transitionin=“dissolve” transitioninduration=“1000”/>
<slide duration=“12167” guid=“ee61ca9b-ce4e-4191-8fd1-b2c5282a287b”
transitionin=“dissolve” transitioninduration=“1000”/>
<slide duration=“4000” guid=“bffdf594-9e42-4d1d-a5e7-334ddf4462ac”
transitionin=“dissolve” transitioninduration=“1000”/>
<slide duration=“4000” guid=“c6bba46d-2bd1-484d-8304-875f4435ceef”
transitionin=“dissolve” transitioninduration=“1000”/>
<slide duration=“4000” guid=“0778ec84-35d8-45bb-a4d0-e69d084638de”
transitionin=“dissolve” transitioninduration=“1000”/>
<slide duration=“4000” guid=“14c8f811-1a21-4ac7-bfc8-ffe95de304da”
transitionin=“dissolve” transitioninduration=“1000”/>
<slide duration=“4000” guid=“03e119dd-4e00-4a59-8ddf-33887542c167”
transitionin=“dissolve” transitioninduration=“1000”/>
<slide duration=“4000” guid=“703d5b96-ff56-4c11-ab38-66e93e521b0c”
transitionin=“dissolve” transitioninduration=“1000”/>
<slide duration=“4000” guid=“131780e9-158b-4234-bb8f-d3e832cf8d58”
transitionin=“dissolve” transitioninduration=“1000”/>
<slide duration=“4000” guid=“daab28c5-a684-42a2-ba5c-e38d9031ffc8”
transitionin=“dissolve” transitioninduration=“1000”/>
</visualtimeline>
-
  <audiotimeline>
<audiotrack duration=“31475” guid=“d3939564-042a-4a2a-a0aa-3c3a04ba157c”
loop=“false” name=“1000_miles_loop_a” starttime=“0” trackduration=“31475”
type=“stock_sound” volume=“1”/>
<audiotrack duration=“25634” guid=“44de2b89-782f-4710-9527-b000a2faa341”
loop=“false” name=“1 Crowds” starttime=“39800” trackduration=“25634”
type=“stock_sound” volume=“1”/>
</audiotimeline>
-
  <texttimeline>
-
  <textoverlay alignment=“center” backgroundalpha=“1” backgroundcolor=“255”
backgroundtype=“rectangle” dropshadow=“false” duration=“9000” email=“null”
fontfamily=“Arial” fontsize=“22” heightRatio=“0.4926829268292683”
starttime=“4000” textcolor=“0” url=“http://www.seattletimes.com”
widthRatio=“0.5962804878048781” xRatio=“0.24518292682926832”
yRatio=“0.35195121951219516”>
<content>Text Overlay
Click here to go somewhere</content>
</textoverlay>
</texttimeline>
-
  <styling>
<redirectlabel>More Info</redirectlabel>
<emaillabel>Inquire</emaillabel>
<directresponsebuttons backgroundcolor=“#7DC900” bordercolor=“#FFFFFF”
textcolor=“#222222”/>
</styling>
-
  <description>
this is the description block for an example mixpo videoad
</description>
<keywords>videoad, mixpo, mountains, skiing</keywords>
</container>
```

What is claimed is:

1. A method for publishing video ads on Web pages, comprising:
i) providing a publisher interface for interactively specifying a video ad by a publisher wherein a video ad comprises one or more media clips and, optionally, one or more interactive controls;
ii) generating by the publisher interface a playlist that specifies the video ad wherein said playlist includes references to said one or more media clips and said optional interactive controls;
iii) storing by the publisher interface the playlist in a storage system;
iv) downloading the playlist from the storage system to a smart media player capable of processing said playlist, in response to a user request; and
v) playing the video ad by the smart media player.

2. The method of claim 1 wherein said playlist is a text file in XML format.

3. The method of claim 1 wherein said smart media player is an Actionscript application that downloads and runs in the Adobe Flash player virtual engine on the client computer.

4. The method of claim 1 wherein said smart media player operates in conjunction with a Web browser and displays the video ad inside a Web page.

5. The method of claim 1 wherein said video ad further comprises text overlays such that clicking on a text overlay by a user causes the display of a pre-defined web page or a lead capture form.

6. The method of claim 1 wherein said media clips are stored in said storage system along with the playlist.

7. The method of claim 1 further comprising the step of customizing a playlist by the server based on geographic information about the user.

8. The method of claim 1 further comprising the step of computing and presenting viewing statistics about a video ad to the publisher of said video ad.

9. A system for publishing video ads on Web pages, comprising:
i) a publisher interface for interactively specifying a video ad by a publisher wherein a video ad comprises one or more media clips and, optionally, one or more interactive controls, and generating a playlist that specifies the video ad wherein said playlist includes references to said one or more media clips and said optional interactive controls;
iii) a data storage for storing said playlist;
iv) a streamer for downloading the playlist from the storage system to a smart media player capable of processing said playlist, in response to a user request; and
v) a smart media player for playing the video ad.

10. The system of claim 9 wherein said playlist is a text file in XML format.

11. The system of claim 9 wherein said smart media player is an Actionscript application that downloads and runs in the Adobe Flash player virtual engine on the client computer.

12. The system of claim 9 wherein said smart media player operates in conjunction with a Web browser and displays the video ad inside a Web page.

13. The system of claim 9 wherein said video ad further comprises text overlays such that clicking on a text overlay by a user causes the display of a pre-defined web page or a lead capture form.

14. The system of claim 9 wherein said media clips are stored in said storage system along with the playlist.

15. The system of claim 9 further comprising an analytics processor for computing and presenting viewing statistics about a video ad to the publisher of said video ad.
